(19) United States
(12) Patent Application Publication
(10) Pub. No.: US 2007/0148504 A1
(43) Pub. Date: Jun. 28, 2007

(54) Maintaining a fluid level in a heat exchanger of a fuel cell system

(76) Inventors: Parshant Dhand, Troy, NY (US); David A. Gutenmann, Clifton Park, NY (US); Vishnu L. Poonamallee, Albany, NY (US)

Correspondence Address: TROP PRUNER & HU, PC, 1616 S. VOSS ROAD, SUITE 750, HOUSTON, TX, 77057-2631, US

(21) Appl. No.: 11/319,031

(22) Filed: Dec. 27, 2005

(51) Int. Cl. H01M 8/04

(52) U.S. Cl. 429/13; 429/26; 429/24

(57) ABSTRACT

A technique includes providing a fluid to a heat exchanger to produce a gas. The technique includes humidifying a flow of a fuel cell system with the gas and regulating a level of the fluid in the heat exchanger based on a temperature of the gas.

### BACKGROUND

The invention generally relates to maintaining a fluid level in a heat exchanger in a fuel cell.

A fuel cell is an electrochemical device that converts chemical energy directly into electrical energy. For example, one type of fuel cell includes a proton exchange membrane (PEM), which permits only protons to pass between an anode and a cathode of the fuel cell. Typically PEM fuel cells employ sulfonic-acid-based ionomers, such as Nafion, and operate in the 60° Celsius (C.) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, such as a cooling subsystem, a cell voltage monitoring subsystem, a control subsystem, a power conditioning subsystem, etc. The particular design of each of these subsystems is a function of the application that the fuel cell system serves.

A typical fuel cell system may include a steam generator for purposes of humidifying a hydrocarbon stream to aid in the autothermal reforming of the stream to produce a reformate flow for the fuel cell stack. The steam generator may include a heat exchanger that contains a reservoir of fluid. For purposes of controlling the production of steam by the steam generator, the fluid level of the reservoir is controlled. This control usually involves the use of a fluid level sensor. However, the fluid level sensor may be relatively unreliable and may be a relatively expensive component of the fuel cell system.

Thus, there exists a continuing need for better ways to maintain a fluid level in a heat exchanger.

### SUMMARY

In an embodiment of the invention, a technique includes providing a fluid to a heat exchanger to produce a gas. The technique includes humidifying a flow of a fuel cell system with the gas and regulating a level of the fluid in the heat exchanger based on a temperature of the gas.

In another embodiment of the invention, a fuel cell system includes a heat exchanger and a control subsystem. The heat exchanger is adapted to receive a fluid and produce gas to humidify a flow of the fuel cell system. The heat exchanger has a fluid reservoir. The control subsystem is adapted to regulate a fluid level of the fluid reservoir based on a temperature of the gas.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a flow diagram depicting a technique to maintain a fluid level in a heat exchanger of the fuel cell system according to an embodiment of the invention.

FIG. 3 is a waveform of an exemplary output steam temperature of the heat exchanger illustrating a technique to maintain a fluid level inside the exchanger according to an embodiment of the invention.

FIG. 4 is a more detailed flow diagram depicting a technique to maintain a fluid level in the heat exchanger according to an embodiment of the invention.

### DETAILED DESCRIPTION

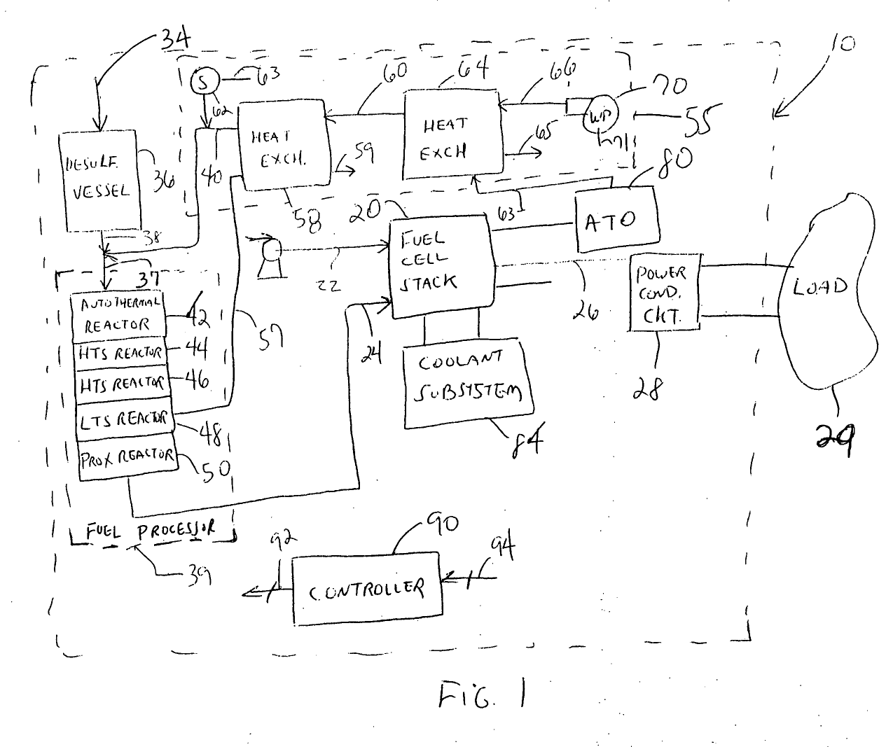

Referring to FIG. 1, a fuel cell stack 20 of a fuel cell system 10 produces power for a load 29 of the system 10. In this regard, the fuel cell stack 20 receives fuel and oxidant flows at an anode inlet 24 and a cathode inlet 22, respectively. In response to these reactant flows, the fuel cell stack 20 produces a DC stack voltage on its stack terminal 26. The DC stack voltage, in turn, is converted into the appropriate form for the load 29 by power conditioning circuitry 28 of the fuel cell system 10.

As an example, for embodiments of the invention in which the load 29 is an AC load, the power conditioning circuitry 28 may include, for example, a DC-to-DC converter for purposes of converting the DC stack voltage into another DC level; and the power conditioning circuitry 28 may include an inverter for purposes of converting this DC voltage into an AC voltage for the load 29. As another example, for embodiments of the invention in which the load 29 is a DC load, the power conditioning circuitry 28 may include a DC-to-DC converter for purposes of regulating the DC stack voltage to the appropriate DC level for the load 29. Thus, many variations are possible and are within the scope of the appended claims.

The fuel flow that is received at the anode inlet 24 is a reformate flow that is produced from an incoming hydrocarbon flow. More specifically, in accordance with some embodiments of the invention, the fuel cell system 10 includes a de-sulfurization vessel 36, which contains a sulfur-absorbent material such as activated carbon and receives (at its inlet 34) an incoming hydrocarbon flow (natural gas or propane, as non-limiting examples). The resultant de-sulfurized hydrocarbon flow exits an outlet 38 of the desulphurization vessel 36 and is routed into an inlet 37 of the fuel processor 39 and more specifically, into the inlet of an autothermal reactor 42 of the fuel processor 39. Before being reacted in the autothermal reactor 42, however, the de-sulfurized hydrocarbon flow is mixed with air and steam. The steam is provided by a steam generator 55, which is further described below. The autothermal reactor 42 produces a converted flow, or “reformate,” which flows through a series of high temperature shift (HTS) reactors 44 and 46, through a low temperature shift (LTS) reactor 48 and then through a preferential oxidation (PROX) reactor 50. The primary function of the series of reactors is maximize hydrogen production, while minimizing carbon monoxide levels in the reformate flow that is provided to the fuel cell stack 20 from the fuel processor 39.

In accordance with some embodiments of the invention, the steam generator 55 is formed from a water pump 70 and two heat exchangers 58 and 64. More particularly, the water pump 70 produces a water flow that enters an inlet 66 of the heat exchanger 64 and is heated inside the heat exchanger 64 via a thermal exchange that occurs in response to an exhaust stream from an anode tail oxidizer 80 (ATO) (for example) that bums any residual fuel that is provided by the fuel cell stack 20. The heated water from the heat exchanger 64 is furnished to an inlet 60 of the heat exchanger 58. Additional thermal energy provided by, for example, exhaust gases from the LTS reactor 48, heats up the incoming water to produce steam that appears at an outlet 40 of the heat exchanger 58.

The heat exchanger 58 contains a reservoir of fluid, which is maintained at a given level for purposes of regulating the steam production by the steam generator 55 and converting the water into the steam for the autothermal reactor 42. Conventionally, a fluid level sensor may be used to monitor the water level inside the heat exchanger 58. However, this sensor may be relatively costly and unreliable. Therefore, in accordance with some embodiments of the invention, the fluid level sensor is replaced with a control scheme in which the water level inside the heat exchanger 58 is regulated by monitoring the output steam temperature of the heat exchanger 58.

More specifically, in accordance with some embodiments of the invention, a temperature sensor 62 is located at the outlet 40 of the heat exchanger 58 for purposes of monitoring the output steam temperature. The sensor 62 may provide, for example, an analog output signal at its output terminal 63 for purposes of indicating the measured steam temperature. A controller 90 of the fuel cell system 10 uses the indication of the temperature from the temperature sensor 62 for purposes of determining the water level in the heat exchanger 58 and regulating operation of the water pump 70. In this regard, in accordance with some embodiments of the invention, the controller 90 may be in communication with one or more control lines 71 of the water pump 70 for purposes of regulating the speed of the pump 70. Thus, when the controller 90 determines (from the signal that is provided by the sensor 62) that the water level in the heat exchanger 58 is too low, the controller 90 increases the water flow from the water pump 70; and conversely, in response to determining that the water level in the heat exchanger 58 is at or above the appropriate level, the controller 90 decreases the water flow from the water pump 70.

As depicted in FIG. 1, in accordance with some embodiments of the invention, the controller 90 may include various input terminals 94 which may be coupled to various sensors of the fuel cell system 10, such as the sensor 62 for purposes of monitoring the status of various temperatures, pressures, voltages, currents, etc. of the fuel cell system 10. Furthermore, one or more of the terminals 94 may be used for purposes of communicating commands and other information to the controller 90. In response to the received signals, the controller 90 furnishes signals on output terminals 92 of the controller 90. These output signals may be used, for example, for purposes of controlling the water pump 70, controlling various motors, pumps and valves of the fuel cell system 10, as well as controlling the fuel processor 39.

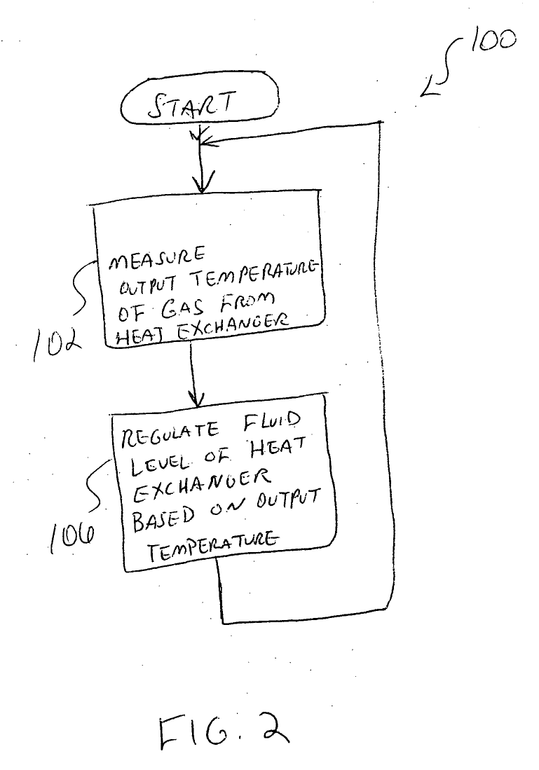

Referring to FIG. 2 in conjunction with FIG. 1, to summarize, in accordance with some embodiments of the invention, the fuel cell system 10 uses a technique 100 to regulate a fluid level of the heat exchanger 58. Pursuant to the technique 100, the fuel cell system 10 measures (block 102) the output temperature of the steam, or gas, which is produced by the heat exchanger 58. The fuel cell system 10 regulates (block 106) the fluid level of the heat exchanger 58 based on the output temperature.

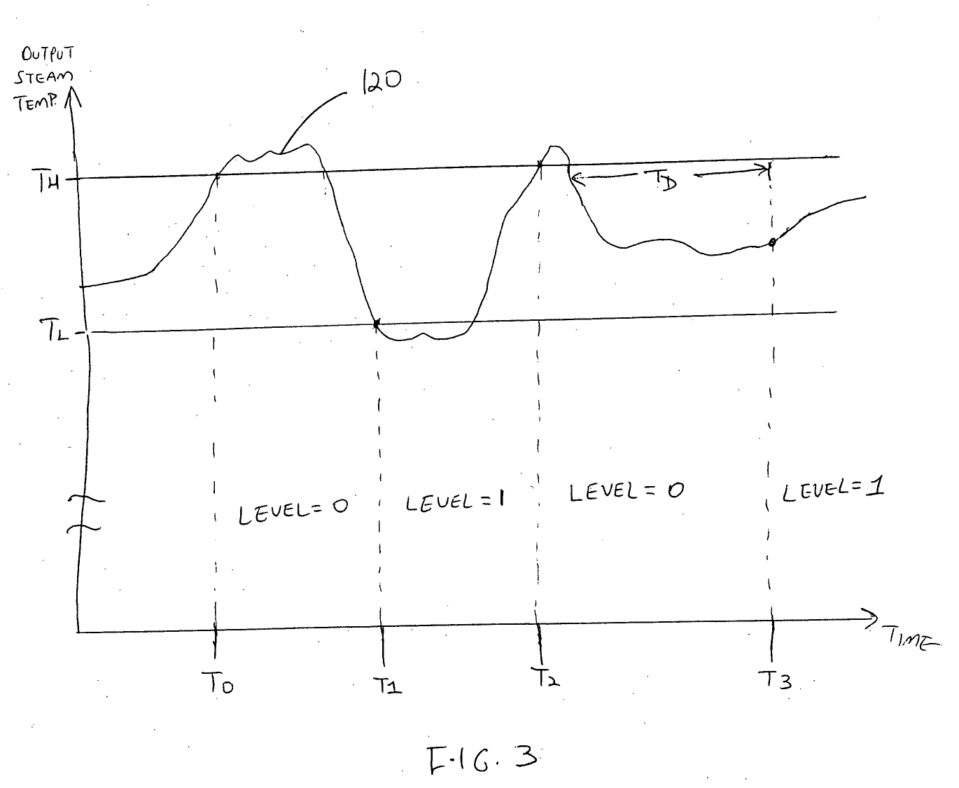

As a more specific example of a technique to regulate the fluid level of the heat exchanger 58 based on the output steam temperature, FIG. 3 depicts an exemplary output steam temperature waveform 120. Times T₀, T₁, T₂ and T₃ depict exemplary times at which the controller 90 changes the control of the water pump 70 in response to the temperature waveform 120. It is noted that the temperature waveform 120 may be a rolling average of the temperature that is indicated by the temperature sensor 62. Thus, in accordance with some embodiments of the invention, the rolling average may be based on a previous number (twenty-five, or example) of temperature measurements. Other variations are possible and are within the scope of the appended claims.

In accordance with some embodiments of the invention, the controller 90 (see FIG. 1) controls the water pump 70 based on the magnitude and timing of the output steam temperature. More specifically, in accordance with some embodiments of the invention, the controller 90 monitors the output steam temperature to determine whether the steam temperature is above an upper temperature threshold (called “T_{H}” in FIG. 3) or below a lower temperature threshold (called “T_{L}” in FIG. 3). In response to the steam temperature exceeding the T_{H} upper temperature threshold, the controller 90 assumes that the water level is low. Thus, as depicted in FIG. 3, a time T₀, the waveform 120 exceeds the T_{H} upper threshold; and in response to this threshold crossing, the controller 90 drives a water level status signal (called “LEVEL” in FIG. 3) to zero to indicate a low fluid level. It is noted that the LEVEL signal may be an analog signal, digital signal or a software parameter, depending on the particular embodiment of the invention.

In response to the low fluid level, in turn, the controller 90 increases the flow output from the water pump 70. As a more specific example, in accordance with some embodiments of the invention, in response to the LEVEL signal being equal to logic zero, the controller 90 linearly decreases the flow output of the water pump 70 over time. Therefore, for the specific example that is depicted in FIG. 3, from time T₀ to time T₁, a time at which another change occurs (as described below), the controller 90 may linearly increase the output flow from the water pump 70. This increased flow, in turn, increases the water level in the heat exchanger 58.

At time T₁, the output steam temperature reaches the T_{L} lower temperature threshold. Upon detecting this threshold crossing, the controller 90 deems that the fluid level inside the heat exchanger 58 to be sufficient and, in response the detection, the controller 90 asserts the LEVEL signal. Therefore, when the controller 90 detects crossing of the T_{L} lower temperature threshold so that the output steam temperature is below this threshold, the controller 90 deems that a sufficient water level exists inside the heat exchanger 58. In response to the LEVEL signal being asserted, the controller 90 decreases the flow from the water pump 70. Thus, in accordance with some embodiments of the invention, over time, in response to the LEVEL signal being equal to logic one, the controller 90 linearly decreases the flow from the water pump 70.

As depicted in FIG. 3, at time T₂, the output steam temperature once again surpasses the T_{H} upper temperature threshold; and in response to this event, the controller 90 de-asserts the LEVEL signal to once again begin decreasing the output flow from the water pump 70.

Thus, to summarize, in accordance with some embodiments of the invention, the controller 90 asserts the LEVEL signal to indicate a sufficient water level inside the heat exchanger 58 in response to the output steam temperature decreasing below the T_{L} low temperature threshold; and the controller 90 de-asserts the LEVEL signal to indicate an insufficient water level inside the heat exchanger 58 in response to the output steam temperature increasing past T_{H} upper temperature threshold. As further described below, the controller 90 may also monitor a timing of the output steam temperature for purposes of determining the water level inside the heat exchanger 58.

More specifically, in accordance with some embodiments of the invention, the controller 90 asserts the LEVEL signal to indicate a sufficient water level inside the heat exchanger 58 in response to the output steam temperature remaining below the upper temperature threshold for a predetermined unit of time. Thus, for this prong of the control scheme to take effect, the temperature remains below the T_{H} upper temperature threshold and above the T_{L} lower temperature threshold. However, by remaining below the T_{H} upper temperature threshold for a predetermined unit of time (5 minutes, for example), the controller 90 deems the fluid level inside the heat exchanger 58 to be sufficient and correspondingly asserts the LEVEL signal. Thus, for the example that is depicted in FIG. 3, after time T₂, the temperature 120 decreases below the T_{H} upper temperature threshold. This event begins the controller's monitoring of the temperature 120 to determine whether the temperature 120 has remained below the T_{H} upper temperature threshold for a predetermined time period (called“T_{D}” in FIG. 3). For this example, the temperature 102 remains within the temperature range defined by the T_{H} upper and T_{L} lower thresholds for the T_{D} duration. At time T₃, when the T_{D} elapses, the controller 90 asserts a LEVEL signal to indicate that a sufficient level of water exists inside the heat exchanger 58.

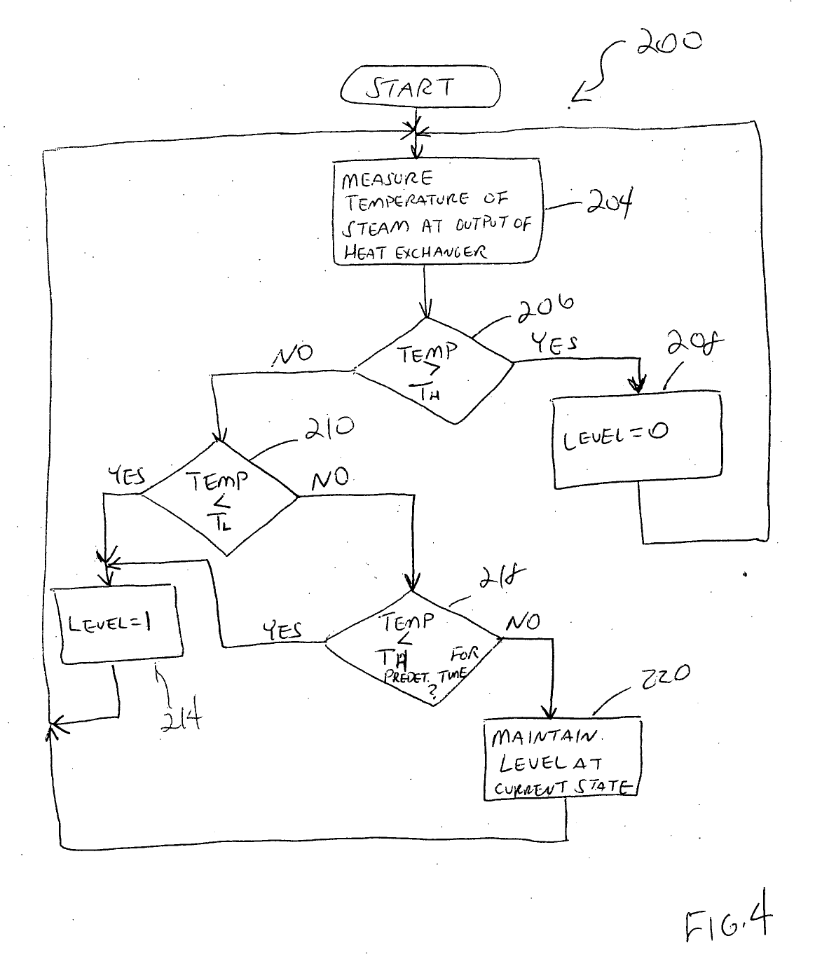

To summarize, referring to FIG. 4, in accordance with some embodiments of the invention, the controller 90 performs a technique 200. Pursuant to the technique 200, the controller 90 uses the signal that is provided by the temperature sensor 62 to measure a temperature of the steam at the output of the heat exchanger 58, pursuant to block 204. It is noted that the temperature that is referenced in FIG. 4 may be an average temperature or may be the instantaneous temperature, depending on the particular embodiment of the invention.

Pursuant to the technique 200, if the controller 90 determines (diamond 206) that the temperature exceeds the T_{H} upper temperature threshold, then the controller 90 de-asserts the LEVEL signal, as depicted in block 208. If the controller determines (diamond 210) that the temperature is less than the T_{L} temperature threshold, then the controller asserts the level signal, as depicted in block 214.

If the controller 90 determines (diamond 206) that temperatures less than the T_{H} upper temperature threshold and determines (diamond 210) that the temperature is greater than the T_{L} lower temperature threshold (i.e., the temperature is within the range defined by the T_{H} and T_{L} temperature thresholds), then the controller 90 determines (diamond 218) whether the temperature has T_{H} upper temperature threshold for a predetermined duration of time. If not, then the controller 90 maintains (block 220) the level signal at its current state. Otherwise, the controller 90 asserts the LEVEL signal, pursuant to block 214.

Other embodiments are possible and are within the scope of the appended claims. For example, in other embodiments of the invention, a temperature sensor may be located at the gas exhaust outlet of the heat exchanger 64, and this sensor may be used in a similar manner to sense a fluid level.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
providing a fluid to a heat exchanger to produce a gas;
humidifying a flow of a fuel cell system with the gas; and
regulating a level of the fluid in the heat exchanger based on a temperature of the gas.

2. The method of claim 1, wherein the act of regulating comprises:
controlling operation of a fluid pump based on the temperature.

3. The method of claim 2, wherein the act of controlling comprises increasing a flow output of the pump over time in response to a determination that the level is low and decreasing a flow output of the pump over time otherwise.

4. The method of claim 1, wherein the act of regulating comprises:
comparing the temperature to an upper temperature threshold and generating an indication that the level is low in response to the temperature exceeding the upper temperature threshold.

5. The method of claim 1, wherein the act of regulating comprises:
comparing the temperature to a lower temperature threshold and generating an indication that the level is high in response to the temperature exceeding the upper temperature threshold.

6. The method of claim 1, wherein the act of regulating comprises:
comparing the temperature to a temperature threshold and generating an indication that the level is high in response to the temperature being below the temperature threshold for a predetermined time.

7. The method of claim 1, wherein the act of regulating comprises:
regulating the level in response to a timing of the temperature.

8. The method of claim 1, wherein the act of regulating comprises:
regulating the level in response to a magnitude of the temperature.

9. The method of claim 1, wherein the act of regulating comprises:
comparing the temperature to an upper temperature threshold and generating an indication that the level is low in response to the temperature exceeding the upper temperature threshold;
comparing the temperature to a lower temperature threshold and generating an indication that the level is high in response to the temperature exceeding the upper temperature threshold; and
comparing the temperature to the upper temperature threshold and generating an indication that the level is high in response to the temperature being below the upper temperature threshold for a predetermined time.

10. The method of claim 1, wherein the act of providing comprises:
flowing the fluid through another heat exchanger; and
subsequently flowing the fluid from said another heat exchanger to the heat exchanger that produces the gas.

11. A fuel cell system, comprising:
a heat exchanger to receive a fluid and produce a gas to humidify a flow of the fuel cell system, the heat exchanger having a fluid reservoir that has a fluid level; and
a control subsystem to regulate the fluid level based on a temperature of the gas.

12. The fuel cell system of claim 11, wherein the control subsystem comprises:
a fluid pump adapted to be controlled based on the temperature.

13. The fuel cell system of claim 12, wherein the control subsystem comprises:
a controller to increase a flow output of the pump over time in response to a determination that the level is low and decrease a flow output of the pump over time otherwise.

14. The fuel cell system of claim 11, wherein the control subsystem comprises:
a temperature sensor to provide a signal indicative of the temperature.

15. The fuel cell system of claim 11, wherein the temperature comprises an average temperature of the gas.

16. The fuel cell system of claim 11, further comprising:
a fuel processor to receive the flow after being humidified by the gas.

17. The fuel cell system of claim 16, wherein the fuel processor comprises an autothermal reactor.

18. The fuel cell system of claim 11, wherein the control subsystem comprises:
a controller to compare the temperature to an upper temperature threshold and generate an indication that the level is low in response to the temperature exceeding the upper temperature threshold.

19. The fuel cell system of claim 11, wherein the control subsystem comprises:
a controller to compare the temperature to a lower temperature threshold and generate an indication that the level is high in response to the temperature exceeding the upper temperature threshold.

20. The fuel cell system of claim 11, wherein the control subsystem comprises:
a controller to compare the temperature to a temperature threshold and generate an indication that the level is high in response to the temperature being below the temperature threshold for a predetermined time.

21. The fuel cell system of claim 11, wherein the control subsystem comprises:
a controller adapted to:
compare the temperature to an upper temperature threshold and generate an indication that the level is low in response to the temperature exceeding the upper temperature threshold,
compare the temperature to a lower temperature threshold and generate an indication that the level is high in response to the temperature exceeding the upper temperature threshold, and
compare the temperature to the upper temperature threshold and generating an indication that the level is high in response to the temperature being below the upper temperature threshold for a predetermined time.

22. The fuel cell system of claim 11, wherein the control subsystem comprises a pump to provide the flow, the fuel cell system further comprising:
another heat exchanger to receive the flow from the pump, said another heat exchanger providing the flow to the heat exchanger that produces the gas.
